(19) United States
(12) Patent Application Publication
(10) Pub. No.: US 2025/0301965 A1
(43) Pub. Date: Oct. 2, 2025

(54) AGRICULTURAL SYSTEM AND METHODS OF USE

(71) Applicant: THOMAS O'CONNOR PRODUCTS LLC, Somerville, MA (US)

(72) Inventor: Thomas O'CONNOR, Somerville, MA (US)

(21) Appl. No.: 19/098,104

(22) Filed: Apr. 2, 2025

Related U.S. Application Data
(60) Provisional application No. 63/573,424, filed on Apr. 2, 2024.
(60) Provisional application No. 63/743,157, filed on Jan. 8, 2025.

(51) Int. Cl. A01G 9/24

(52) U.S. Cl. CPC A01G 9/246; A01G 9/249

(57) ABSTRACT

In one embodiment, an agricultural system includes a core assembly and includes a housing forming main aperture; a light source arranged circumferentially around the main aperture; and one or more air movers directed toward the main aperture. The main aperture defines an inlet and an outlet fluidically coupled by a flow passage formed by the housing.

### CROSS REFERENCE TO RELATED APPLICATIONS

This application claims the benefit of priority under 35 U.S.C. § 119(e) and 37 C.F.R. § 1.78 to provisional application No. 63/573,424 filed on Apr. 2, 2024, titled “Agricultural System and Methods of Use”, and to provisional application No. 63/743,157 filed on Jan. 8, 2025, titled “Agricultural System and Methods of Use” all of which are hereby incorporated by reference herein in their entireties.

### BACKGROUND

Indoor plant growth systems are widely utilized in a range of settings, from residential spaces, to commercial greenhouses, and indoor farming facilities. However, existing systems present significant limitations that hinder their overall effectiveness and the health of the plants they are intended to nurture.

For example, while existing systems may provide light, they do not provide for airflow as a plant would experience outside. Inadequate airflow within traditional indoor plant growth systems can give rise to a host of challenges. Insufficient ventilation and air circulation impedes the exchange of gases necessary for photosynthesis. The build-up of stagnant air within these systems can also lead to an increased risk of mold, mildew, and other pathogens, jeopardizing the health and vitality of the plants being cultivated.

Furthermore, plants cultivated without adequate exposure to air movement often exhibit characteristics of weakness and fragility. These plants tend to display a lack of substantive growth, resulting in a spindly and frail appearance that compromises their overall health and productivity. The absence of natural environmental cues, such as gentle breezes, can lead to the underdevelopment of crucial supportive tissues, impeding the plant's ability to withstand environmental stressors and limiting its potential for robust growth.

### BRIEF SUMMARY

In one embodiment, an agricultural system includes a core assembly including a housing forming main aperture; a light source arranged circumferentially around the main aperture; and one or more air movers directed toward the main aperture, wherein the main aperture defines an inlet and an outlet fluidically coupled by a flow passage formed by the housing.

Optionally, in some embodiments, the agricultural system includes an input configured to control an intensity of light emitted by the light source.

Optionally in some embodiments, the agricultural system includes an input configured to control an intensity of airflow generated by the one or more air movers.

Optionally in some embodiments, the agricultural system includes an input configured to control an operation time of the agricultural system.

Optionally, in some embodiments, the housing is formed from a circumferential rim including a bottom portion, a mid portion, and a top portion.

Optionally, in some embodiments, the core assembly is configured to provide light and air in a substantially same direction.

Optionally, in some embodiments, a light modifier is arranged about the main aperture and adapted to modify light provided by the light source.

Optionally, in some embodiments, the modification includes at least one of collimating the light or diffusing the light.

Optionally, in some embodiments, the light modifier includes a lens or a diffuser.

Optionally, in some embodiments, the light modifier includes a Fresnel lens or a convex lens.

Optionally, in some embodiments, the light source includes a plurality of tunable LED emitters.

Optionally, in some embodiments, the tunable LED emitters are adapted to change a light spectrum based on at least one of a plant species or growth stage.

Optionally, in some embodiments, the air mover includes a fan driven by a pulse-width-modulation signal, a DC signal, or an AC signal and configured to provide adjustable airflow based on at least one of a plant species or growth stage.

Optionally, in some embodiments, the agricultural system includes a base adapted to stably support the agricultural system on a support surface; and a support coupled to the housing and the base.

Optionally, in some embodiments, the support includes at least one of an elongated rod or a cord.

Optionally, in some embodiments, wherein the support is adjustable in length.

### BRIEF DESCRIPTION OF THE DRAWINGS

FIG. 1 is a schematic of an agricultural system.

FIG. 2A is a front isometric view of an embodiment of the agricultural system of FIG. 1.

FIG. 2B is a rear isometric view of the embodiment of the agricultural system of FIG. 2B.

FIG. 2C is an exploded view of the embodiment of the agricultural system of FIG. 2A.

FIG. 2D is an elevation view of an example of a light source of the agricultural system of FIG. 2A.

FIG. 2E is a cross section of the agricultural system of FIG. 2A taken along line 2F-2F of FIG. 2A.

FIG. 3 is a front isometric view of an embodiment of the agricultural system of FIG. 1.

FIG. 4 is a front isometric view of an embodiment of the agricultural system of FIG. 1.

FIG. 5 is a top isometric view of an embodiment of the agricultural system of FIG. 1.

FIG. 6A is a front isometric view of an embodiment of the agricultural system of FIG. 1.

FIG. 6B is a cross section of the agricultural system of FIG. 6A taken along line 6B-6B of FIG. 6A.

FIG. 7 is a front isometric view of an embodiment of the agricultural system of FIG. 1.

FIG. 8 is a simplified block diagram of components of an embodiment of the agricultural system of FIG. 1.

### DETAILED DESCRIPTION

The systems and methods herein provide an integrated agricultural system that enables indoor plants to receive both light and airflow to promote strong growth. In many embodiments, an agricultural system includes a support structure that houses a light source and an air mover. In some embodiments, the light source may be situated to illuminate plants from a side, rather than from the top, thereby increasing the effective area over which light may be supplied to the plants. In some embodiments, the agricultural system may be situated to provide airflow and light from above, such as where plants may benefit from such orientation. In many embodiments, the air mover may be situated such that airflow is provided to the plants in a same or similar direction as the illumination.

The disclosed systems overcome limitations of existing systems by providing both light and airflow to indoor plants to more accurately mimic ideal growing conditions and conditions the plants would experience outdoors. For example, integrating controlled airflow into indoor plant growth systems not only addresses the limitation of stagnant air but also contributes to the cultivation of healthier, more resilient plants with enhanced growth characteristics. Furthermore, the movement imparted to plants by airflow tends to result in stronger, more robust plant, as plants subjected to gentle movement (e.g., due to airflow), typically respond by developing stronger stems and sturdier foliage.

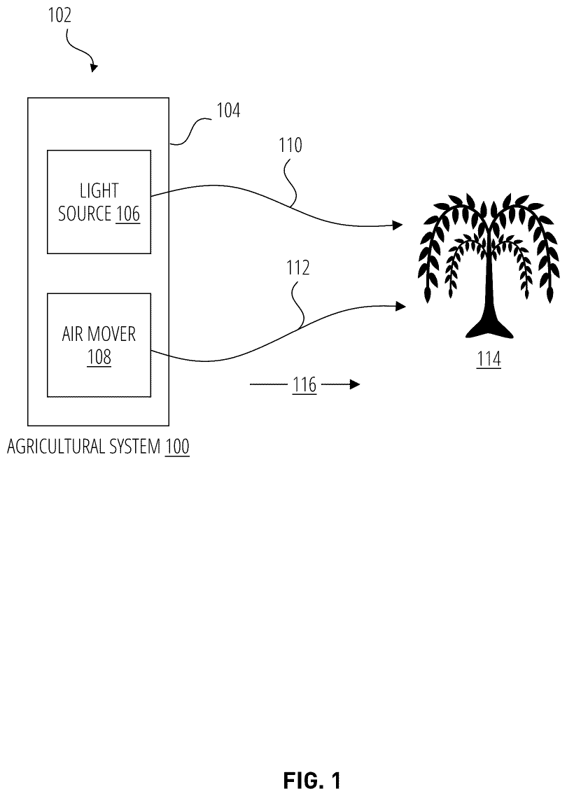

Turning to the figures, FIG. 1 illustrates a simplified schematic of an agricultural system 100. The agricultural system 100 is adapted to provide light 110 and air 112 to a plant 114. In many embodiments, the agricultural system 100 provides air 112 and/or light 110 to the plant 114 in substantially the same direction 116. When discussing the air 112 or light 110 moving substantially in one direction, this concept allows for slight variations for divergence from the overall direction 116. For example, in the case of air 112 movement, while the air 112 may predominantly move in the direction 116, there may be eddies, convection currents, etc. within the overall direction 116 that are in another direction (even opposite direction) locally. Similarly, in the case of the light 110, the light rays may predominantly move along the direction 116 but may be subject to scattering or diffusion (either in the atmosphere and/or from the light modifier 220) is in a direction other than the predominant direction. These variations are considered to be included in the direction 116.

For example, the direction 116 may be a substantially horizontal direction that may enable the agricultural system 100 to provide light 110 and/or air 112 to a plant 114 from the side. In some embodiments, the agricultural system 100 provides light 110 and air 112 to the plant 114 from above the plant 114 (e.g., the direction 116 is substantially vertically downward).

The agricultural system 100 includes a core assembly 102 with a housing 104 that encloses, or supports a light source 106 and one or more air movers 108. The light source 106 provides the light 110 to the plant 114. The air mover 108 provides the air 112 to the plant 114. In some embodiments, either the light source 106 or the air mover 108 may be optional.

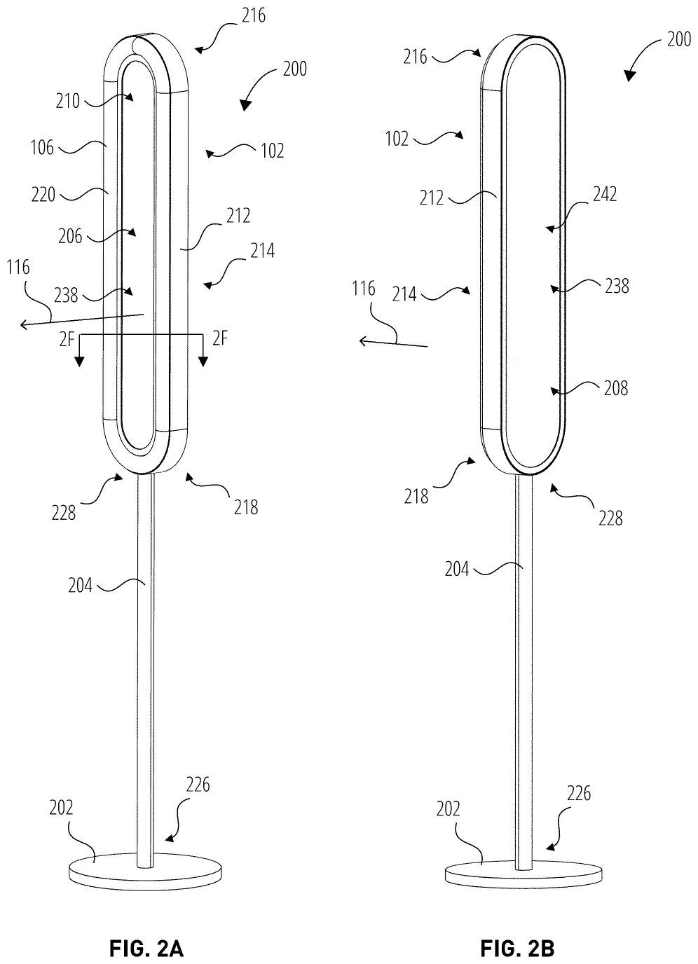

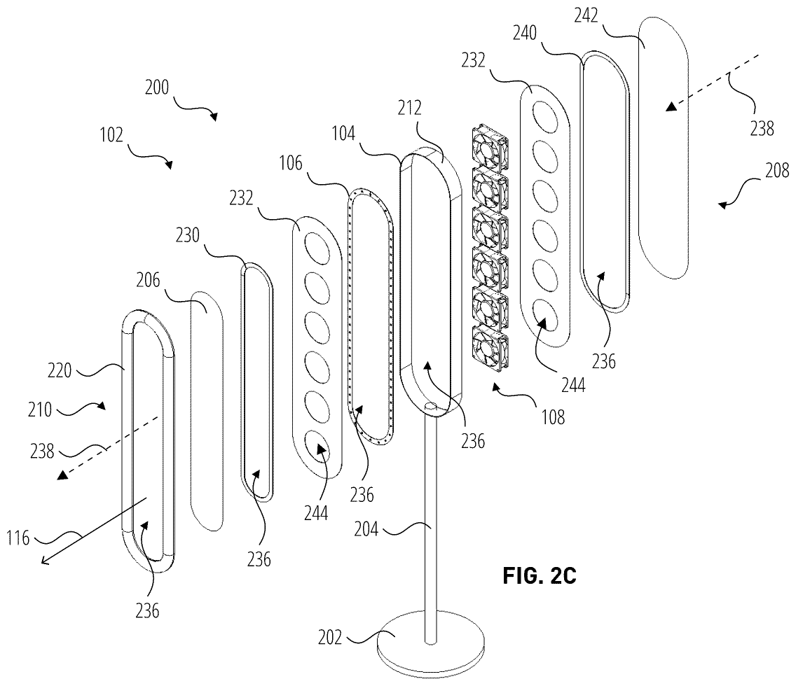

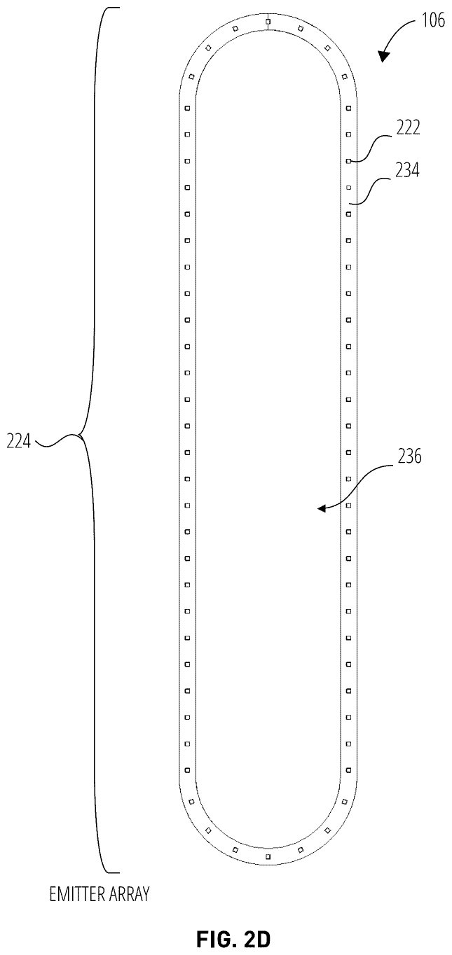

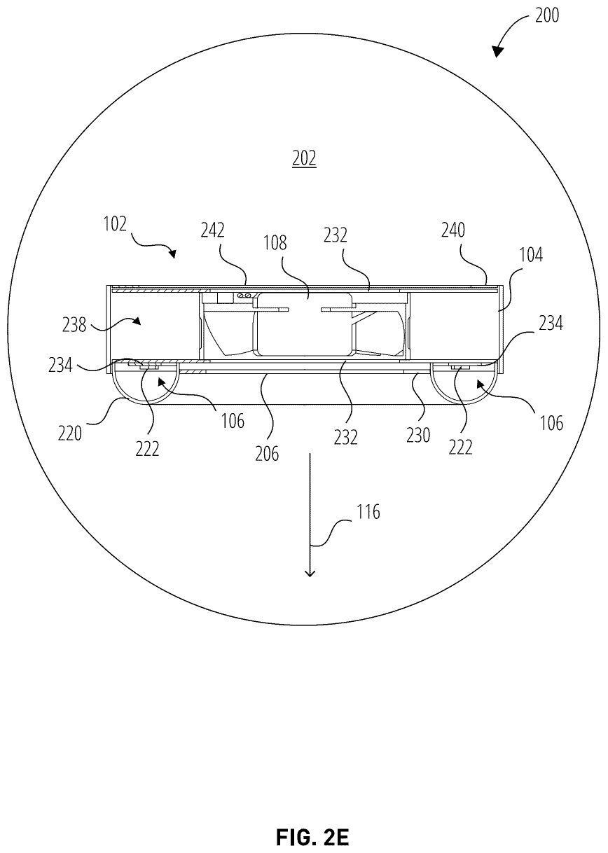

With reference to FIG. 2A-FIG. 2E, a specific example 200 of an agricultural system 100 is shown. As with the agricultural system 100, the agricultural system 200 includes core assembly 102 that includes a housing 104, a light source 106, and an air mover 108. The agricultural system 200 may be adapted to provide light and/or airflow to a plant 114. In many embodiments, the agricultural system 200 provides light 110 and air 112 to the plant 114 in substantially the same direction 116.

The core assembly 102 includes many of the components of the agricultural system 200. For example, the core assembly 102 includes a housing 104 that contains and supports the light source 106 and/or the air mover 108. In many embodiments, the housing 104 is formed from a circumferential rim 212. As shown for example in FIG. 2A, the rim 212 may have an oval or rounded columnar shape. For example, the rim 212 may have a bottom portion 218, a mid portion 214 coupled to the bottom portion 218, and a top portion 216 coupled to the mid portion 214. In many embodiments, the top portion 216 and the bottom portion 218 are substantially hemi cylindrical in shape (e.g., have a half-circle cross section). In many embodiments, the mid portion 214 is substantially rectangular in shape. Coupling the bottom portion 218, the mid portion 214, and the top portion 216, the overall shape of the housing 104 becomes ovular or having a rounded columnar shape. Other shapes of rims 212, such as rectangles, squares, circles, other polygons or other irregular shapes are contemplated within the scope of this disclosure.

The housing 104 defines a main aperture 236 through which air 112 is directed by the one or more air movers 108. For example, the main aperture 236 may define an inlet 208 (e.g., at the rear of the core assembly 102 that takes air into the core assembly 102) and an outlet 210 (e.g., at the front of the core assembly 102 through which air is expelled in the direction 116). The inlet 208 and the outlet 210 may be fluidically coupled by a flow passage 238 formed in the core assembly 102. The light source 106 may be arranged circumferentially around the central main aperture 236 (e.g., between the edge of the main aperture 236 and the rim 212). The light source 106 may direct light 110 in the direction 116, The core assembly 102 may include a front grille 206 and a rear grille 242. The grilles may help prevent or reduce interference with the air movers 108. For example, the front grille 206 and/or the rear grille 242 may be screens or perforated sheets that reduce or prevent a person from inadvertently inserting a finger into the air movers 108 and being injured. The front grille 206 and the rear grille 242 are air-permeable, allowing air 112 to be drawn into the agricultural system 200 (e.g., at the rear) and expelled (e.g., at the front) in the direction 116. In some embodiments, one or both of the front grille 206 and the rear grille 242 may provide a filtering function to remove particulates or other unwanted constituents from the air 112.

The agricultural system 200 may include a base 202 that stably supports the agricultural system 200 on a support surface such as a floor, ceiling, or table top. The example of the base 202 shown is disc-shaped, but other shapes such as squares, rectangles, other polygons or irregular shapes may be used. In some embodiments, the base 202 may be weighted, or attachable to a support surface such as a floor or ceiling. The base 202 may be adapted to prevent or reduce the risk of the agricultural system 200 toppling, e.g., due to being bumped, or to the thrust force generated by the air mover 108.

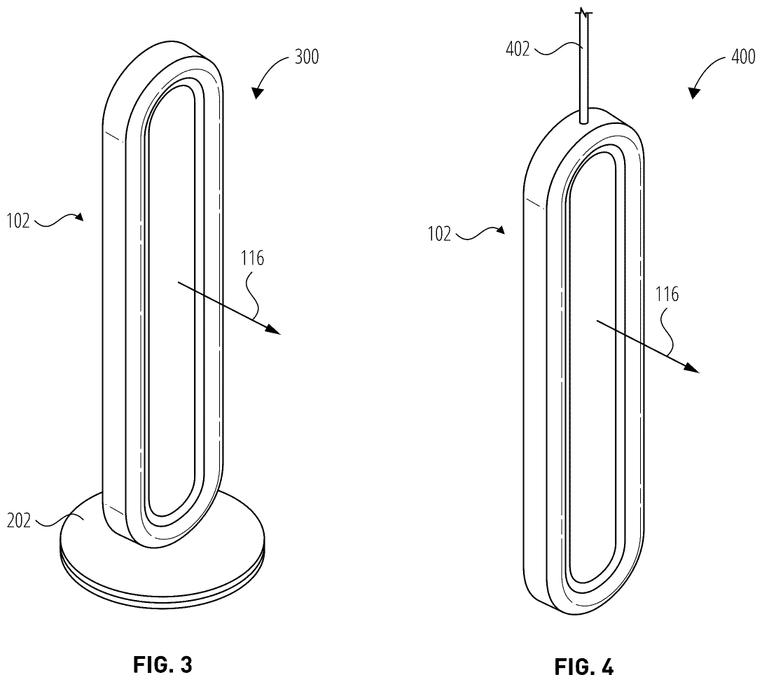

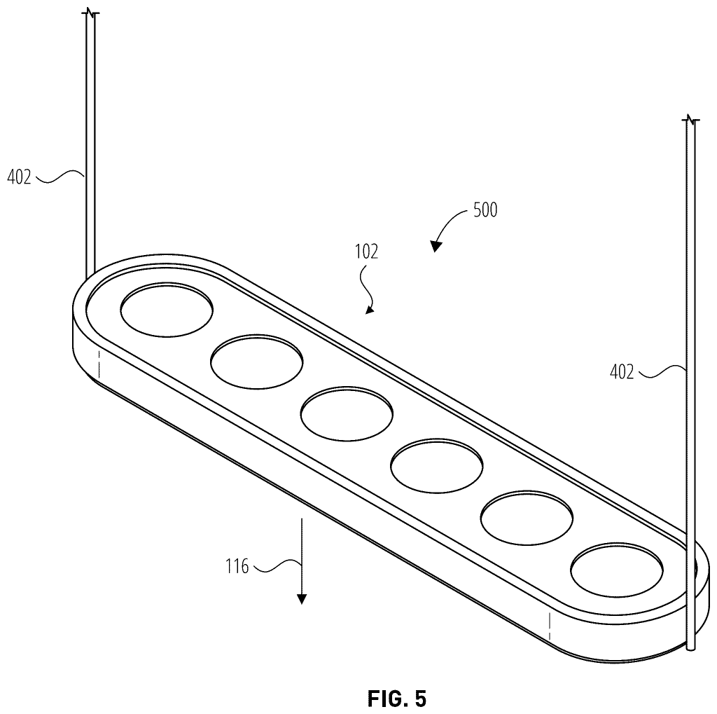

With specific reference to FIG. 2A and FIG. 2B, a support 204 may extend away from the base 202 (e.g., upward when the agricultural system 200 is placed on a floor or table, and downward when the agricultural system 200 is coupled to a ceiling or the like). The support 204 may locate the housing 104 with respect to a plant 114. For example, the support 204 may raise or lower the housing 104 to be at a similar level as a plant 114. The support 204 may be an elongated rod. A first end 226 of the support 204 may be coupled to the base 202 and a second end 228, opposite the first end 226, may be coupled to the core assembly 102, such as to the housing 104. In various embodiments, the support 204 may be coupled to the base 202 and/or the housing 104 by a fastener such as a screw or bolt, by an adhesive, or may be integrally formed with either or both of the base 202 and support 204. In some embodiments, the support 204 may be adjustable. In some embodiments, the support 204 may be of fixed length. In some embodiments, a kit including different supports 204 of different lengths may be provided. In some embodiments, the support 204 may be optional. For example, in some embodiments, an agricultural system 200 may be adapted to be placed on a table top (see., e.g., the agricultural system 300 discussed with respect to FIG. 3) or counter or the like, and the height provided by the support 204 may not be needed. In another example, the support 204 may be a cord 402 adapted to suspend the core assembly 102 from a support surface such as a ceiling. See, e.g., the agricultural system 400 discussed with respect to FIG. 4. In some embodiments, more than one support 204 may be used. For example, the support 204 may be two or more cords 402 adapted to suspend the core assembly 102 from a support surface such as a ceiling, e.g., in a substantially horizontal orientation. See, e.g., the agricultural system 500 discussed with respect to FIG. 5. In another example, two supports 204 in the form of elongated rods may be used and the core assembly 102 may be coupled therebetween.

Turning to FIG. 2C, a partially exploded view of the agricultural system 200 is shown. As discussed, the agricultural system 200 includes a light modifier 220, a front grille 206, a light source 106, a housing 104 formed by a rim 212, one or more air movers 108, and a rear grille 242. Also shown in FIG. 2C are a front gasket 230, one or more masks 232, and a rear gasket 240. As shown for example in FIG. 2C, the agricultural system 200 includes a main aperture 236 that forms a flow passage 238 through the components of the core assembly 102. For example, the light modifier 220, the front gasket 230, the light source 106, the rim 212, the rear gasket 240 all may include a main aperture 236 therein. The main aperture 236 generally conforms to the shape of the rim 212, such that, when assembled, the components form a flow passage 238 through the core assembly 102.

The light modifier 220 has a shape that generally conforms to the rim 212 (e.g., is ovular or a rounded columnar shape with a main aperture 236). The light modifier 220 changes or modifies a property of the light 110 generated by the light source 106. In some embodiments, the light modifier 220, may be a lens or a diffuser. In examples, where the light modifier 220 includes a lens, it may collimate the light 110 or it may spread or diverge the light 110. In some embodiments, the lens may be a Fresnel or convex lens that controls the spread or divergence of the light 110, thereby resulting in a sharper focus and/or increased intensity. In embodiments where the light modifier 220 includes a diffuser, the 220 may scatter the light 110 rays in different directions, softening shadows and reducing harsh contrasts. Light 110 passing through a diffuser becomes more evenly distributed and/or uniform. In some embodiments, the diffuser may be a partially frosted element such as glass or plastic. Other types of diffusers, including grid diffusers and honeycomb grids, may further refine and direct the light 110. The light modifier 220 may also protect the light source 106 from contamination, interference, or the like.

The front gasket 230 has a shape that generally conforms to the rim 212 (e.g., is ovular or a rounded columnar shape with a main aperture 236). The front gasket 230 acts as an interface between the mask 232 and the front grille 206 and may seal or attach the front grille 206 to the mask 232. In some embodiments, the front gasket 230 may include an adhesive layer such that the front gasket 230 sticks to the mask 232 and/or the front grille 206.

Similarly, the rear gasket 240 has a shape that generally conforms to the rim 212 (e.g., is ovular or a rounded columnar shape with a main aperture 236). The rear gasket 240 acts as an interface between the mask 232 and the rear grille 242 and may seal or attach the rear grille 242 to the mask 232. In some embodiments, the rear gasket 240 may include an adhesive layer such that the rear gasket 240 sticks to the mask 232 and/or the rear grille 242. See, e.g., the cross section of FIG. 2E. Either or both of the front gasket 230 and/or rear gasket 240 may be formed from a material such as an elastomer to provide some “give” and flexibility in assembly, and to accommodate for manufacturing tolerances in the grilles and/or masks 232.

The mask 232 has a shape that generally conforms to the rim 212 (e.g., is ovular or a rounded columnar shape with a main aperture 236). As shown for example in FIG. 2C, more than one mask 232 may be used. For example, a first mask 232 may be included proximate to the front grille 206 and a second mask included proximate to the rear grille 242.

The mask 232 may be formed of a thin sheet of a material such as metal or plastic and may have one or more cowls 244 formed therein. Typically, one cowl 244 will be used for each air mover 108. The cowl 244 may be a circular or cylindrical covering that surrounds a portion of the intake or outlet of the air movers 108 (e.g., the fan blades or impeller). The cowl 244 may guide and control the airflow generated by the light source 106, as well as to protect the blades and facilitate efficient air circulation. The cowls 244 are substantially aligned with the air movers 108 within the core assembly 102.

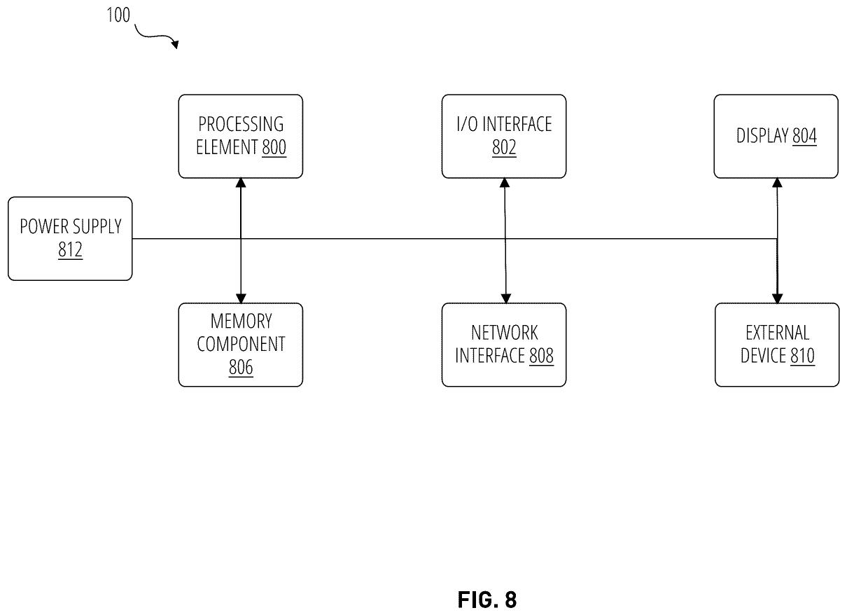

The one or more air movers 108 may be substantially any device adapted to move air or any other gas. In some embodiments, the air movers 108 are axial brushless DC fans. In such examples, the air mover 108 include a brushless DC motor, which eliminates the need for brushes, thus reducing friction and extending the air mover 108's life span. In some embodiments, the brushless DC motor may be powered by a 12 V, 24 V, 48 V, power supply 812. See, e.g., FIG. 8 and related discussion. Other types of air movers 108 include centrifugal air movers 108, which utilize rotating impellers to increase the pressure of the air 112 stream. Such air movers 108 may be used when a higher pressure than can be afforded by an axial fan is desired (e.g., when the rear grille 242 and/or front grille 206 include filtering aspects). The air mover 108 may be driven at the same speed relative to one another or may be driven at different speeds (e.g., some may turn more slowly than others). The air movers 108 may be driven by a pulse-width-modulation signal, a DC signal, an AC signal, or other appropriate signal. Driving the air movers 108 at various speeds affects the volume and speed of the air 112 and may be tuned as desired (e.g., lower speed for younger or more tender plants, or higher speed for more robust plants, etc.). In the example agricultural system 200, six individual air movers 108 are shown. More or fewer air movers may be used as desired.

As shown for example in FIG. 2C and in more detail in FIG. 2D, the light source 106 may include one or more emitters 222 such as individual light emitting diodes (“LED”), light bulbs, high intensity discharge tubes, fluorescent tubes, etc. The emitters 222 may be supported on and/or have power distributed by a substrate 234 such as a printed circuit board (PCB). In some embodiments, the substrate may be a backing board and power may be distributed to the emitters 222 via wires rather than etched traces in a PCB. The substrate 234 and the emitter array 224 in which the emitters 222 are placed may have a shape that generally conforms to the rim 212 (e.g., is ovular or a rounded columnar shape with a main aperture 236), with a main aperture 236 therein.

In some embodiments, the emitters 222 may be designed for plant growth such as by emitting light 110 in specific wavelengths of tailored to support photosynthesis and plant growth. The emitters 222 may be tunable to emit different wavelengths such as to provide the light spectrum for different stages of plant 114 development, e.g., from seedling to flowering. For instance, so called “full-spectrum” LED emitters 222 may emit a broad range of wavelengths including blue light for vegetative growth, red light for flowering, and some green and white light for balanced growth and visual appeal. For example, the emitters 222 may emit light having a wavelength of approximately 440-490 nm for blue light, approximately 620-750 nm for red light, approximately 495-570 nm for green light, and typically around 380-780 nm for visible white light.

The emitters 222 may be tunable (e.g., based on a signal from a processing element 800) to emit different colors of wavelengths, brightness, or intensities of light. Tunable emitters 222 may allow growers to adjust the light spectrum based on the specific needs of different plant species or growth stages. By fine-tuning the light wavelengths, growers can optimize photosynthetic efficiency and overall plant health. Furthermore the emitters 222 may be dimmable such as to enable precise control over light intensity, allowing for adjustments to accommodate the light requirements of sensitive plants or to create optimal lighting conditions in a controlled indoor environment. Dimmable emitters 222 can also simulate natural conditions such as sunrise, sunset, or cloud cover. In addition to visible light, some emitters 222 may incorporate ultraviolet (UV) and far-red wavelengths to elicit specific plant responses, such as enhanced flowering, fruiting, or defense mechanisms. Such tailored light spectrums can enable the agricultural system 100 to support diverse plant species and cultivation goals. Emitters may have different color temperatures of white light and or different color rendering indices to support various plant growth goals.

FIG. 3 shows an example of an agricultural system 300. The agricultural system 300 includes a core assembly 102 as discussed herein. The agricultural system 300 may be adapted to be placed on a table top or counter top and may omit the support 204. The agricultural system 300 includes a base 202 for stability. The agricultural system 300 emits light 110 and air 112 substantially in the direction 116 (e.g., horizontally).

FIG. 4 shows an example of an agricultural system 400. The agricultural system 400 includes a core assembly 102 as discussed herein. The agricultural system 400 may be adapted to be supported from an overhead structure such as a ceiling, awning, or overhead stand. In the agricultural system 400, the support 204 may be in the form of a cord 402. The cord 402 may include power wires to supply electricity to the agricultural system 400 and/or may also include structural elements (e.g., a filament or rope) to support the weight of the agricultural system 400. The agricultural system 400 emits light 110 and air 112 substantially in the direction 116 (e.g., horizontally)

FIG. 5 shows an example of an agricultural system 500. The agricultural system 500 includes a core assembly 102 as discussed herein. The agricultural system 400 may be adapted to be supported from an overhead structure such as a ceiling, awning, or overhead stand. In the agricultural system 500, the support 204 may be in the form of two or more cords 402. One or more of the cords 402 may include power wires to supply electricity to the agricultural system 500 and/or may also include structural elements (e.g., a filament or rope) to support the weight of the agricultural system 500. The agricultural system 500 may be adapted to be mounted in a horizontal or sloped fashion from the overhead support structure. The agricultural system 500 emits light 110 and air 112 substantially in the direction 116 (e.g., vertically).

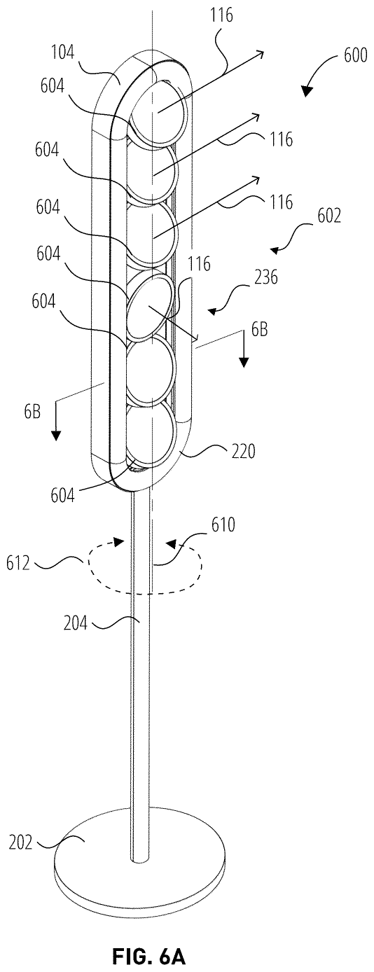

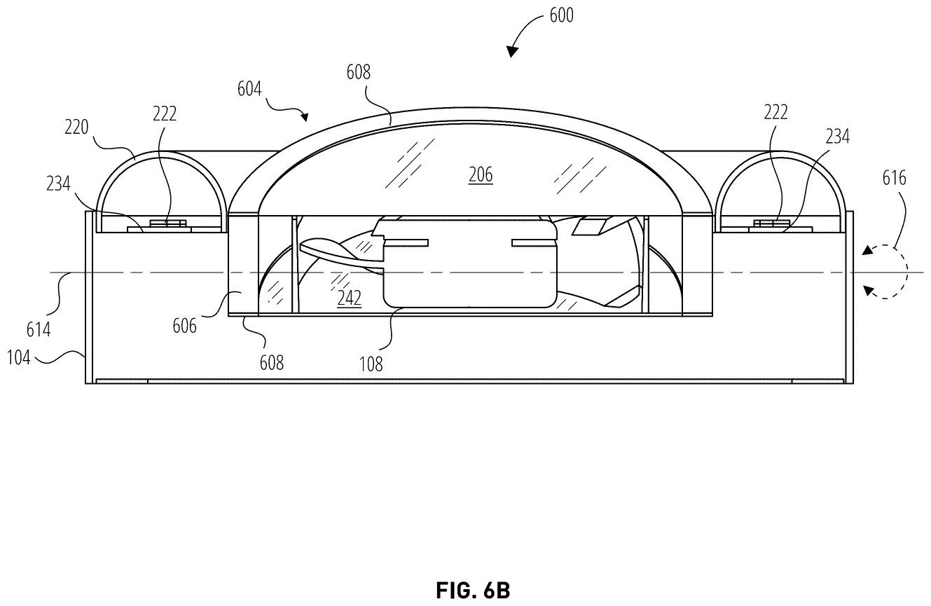

With reference to FIG. 6A and FIG. 6B, an agricultural system 600 includes a core assembly 602. The core assembly 602 may be similar to other core assemblies 102 disclosed herein. For example, the core assembly 602 may include a housing 104, one or more air movers 108, and a light source 106, etc. The core assembly 602 may be mountable as described with respect to the core assembly 102 (e.g., as discussed and shown with respect to the agricultural system 100, agricultural system 200, agricultural system 300, agricultural system 400, or agricultural system 500).

The agricultural system 600 may differ from the core assembly 102 in that it includes one or more nacelles 604 that house respective air movers 108. As shown for example in FIG. 6B, the nacelle 604 includes a wall 606 with a front grille 206 and a rear grille 242. As shown for example in FIG. 6B, the wall 606 may be in the form of a shortened cylinder, that extends along an axis sufficiently to enclose an air mover 108. In other embodiments, the wall 606 may have other shapes, such as an oval, rectangle, square, etc. suitable to enclose a desired air mover. For example, a nacelle 604 may be oval-shaped when it encloses two or more air mover 108. The front grille 206 and rear grille 242 may function as described herein (e.g., may allow airflow therethrough, and may have a filtering function) but may be adapted to be received on a single nacelle 604. The front grille 206 and rear grille 242 may be secured to the wall 606 by respective caps 608. For example, the front grille 206 and rear grille 242 may be sandwiched between their respective caps 608 and the wall 606. In some embodiments, the caps 608, front grille 206, and/or rear grille 242 may be removable such as to facilitate cleaning.

As with other agricultural systems disclosed, the direction 116 of the air 112 moved by the air movers 108 may generally be directed toward the main aperture, wherein the main aperture defines an inlet and an outlet fluidically coupled by a flow passage formed by the housing. However, the nacelles 604 may be pivotable or rotatable about one or more axes relative to the housing 104 and/or relative to one another. As shown for example in FIG. 6A, the one or more nacelles 604 may be pivotable about an axis 610 in a direction 612. As shown for example in FIG. 6B, the one or more nacelles 604 may be pivotable about an axis 614 in a direction 616. In some embodiments, the direction 612 and the axis 614 are disposed at an angle with respect to one another. For example, the direction 612 and the axis 614 May be disposed at 90°, 80°, 70°, 60°, 50°, 40°, 30° 20°, 10° with respect to one another. The core assembly 602 may have the benefit of providing air 112 in multiple directions 116. For example, if a user has multiple plants 114 at different heights, or lateral locations, relative to the agricultural system 600, individual nacelles 604, or groups of nacelles 604 can be easily directed toward the appropriate plant 114 without moving the whole agricultural system 600.

In some embodiments, the nacelles 604 may be manually pivotable about the one or more axes 610 and/or 614. In some embodiments, the nacelles 604 may be automatically pivotable about the one or more axes 610 and/or 614, such as via a motor, actuator, servo, gear transmission, belt, pulley, chain, etc.

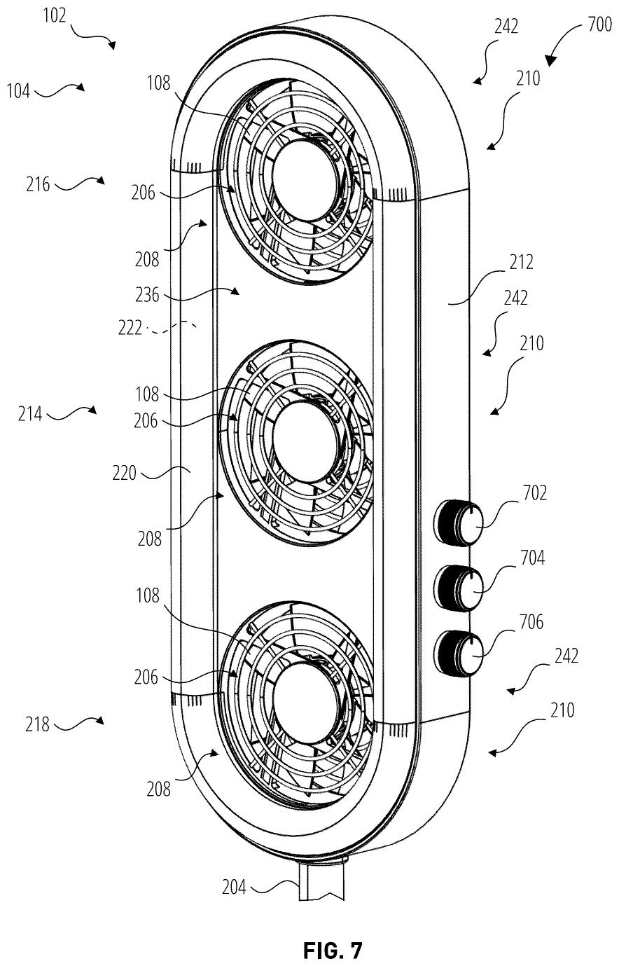

Turning to FIG. 7, an embodiment of an agricultural system 700 is shown. The agricultural system 700 is similar to the agricultural systems 100, 200, 300, 400, 500, and 600 in many aspects. The agricultural system 700 includes a core assembly 102 with a housing 104 that forms a main body of the agricultural system 700. The housing 104 has a rim 212 arrayed around and forming a main aperture 236. The rim 212 may be coupled to a base 202 to support the agricultural system 100 on a support surface such as the floor. The agricultural system 700 includes a support 204 like the agricultural system 200, but is also suitable for mounting as described with respect to the agricultural system 300, agricultural system 400, and/or agricultural system 500.

For example, the agricultural system 700 includes one or more air movers 108 (e.g., three air movers 108 in the embodiment shown). The agricultural system 700 may have more or fewer air movers 108 than shown in FIG. 7. The air movers 108 have inlets 208 and outlets 210 located behind respective front grilles 206 and rear grilles 242. In some embodiments, two or more of the air movers 108 may be oriented in different (e.g., opposite) flow directions, such that the inlets 208 and outlets 210 are switched with respect to the embodiment shown in FIG. 7. For example, the air mover 108 in the top portion 216 and bottom portion 218 may be oriented to direct air in a first direction, while the air mover 108 in the mid portion 214 is oriented to direct air in a second, opposite direction with respect to the air movers 108 in the top portion 216 and the bottom portion 218.

The agricultural system 700 also includes one or more light source 106 such as emitters 222 in an emitter array 224 disposed about a main aperture 236 of the agricultural system 700. The emitters 222 may be placed in relation to a light modifier 220 that changes an aspect of the light passing therethrough (e.g., may redirect, focus, diffuse, color the light from the emitters 222, etc.)

The agricultural system 700 may include one or more user controls, such as a first input 702, a second input 704, and/or a third input 706. Any of the first input 702, second input 704, and/or third input 706 may configure one or more aspects of the operation of the agricultural system 700. For example, the first input 702 may accept a user input to change an intensity or direction of the airflow of the air movers 108. The first input 702 may also turn the agricultural system 700 on or off. In another example, the second input 704 may change an intensity or light color of the light emitted by the emitters 222 (e.g., may cause the emitters 222 to emit more or less light, and/or change the light color). In another example, the third input 706 may control a timer function that controls when or how long the agricultural system 700 operates. any of the first input 702, second input 704, and/or third input 706 may be knobs, buttons, switches, analog controls, rheostats, digital controls, or the like suitable to accept a user input.

FIG. 8 is a simplified block diagram of components of an agricultural system, such as the agricultural system 100, the agricultural system 200, the agricultural system 300, the agricultural system 400, and/or the agricultural system 500. For example, the processing element 800 and the memory component 806 may be located at one or in several agricultural systems. This disclosure contemplates any suitable number of such agricultural systems. An agricultural system 100 may include one or more processing elements 800, an input/output I/O interface 802, one or more external devices 810, one or more memory components 806, and a network interface 808. Each of the various components may be in communication with one another through one or more buses or communication networks, such as wired or wireless networks. The components in FIG. 8 are exemplary only. In various examples, the agricultural system may include additional components and/or functionality not shown in FIG. 8. One or more of the components in FIG. 8 may be optional.

The processing element 800 may be any type of electronic device capable of processing, receiving, and/or transmitting instructions. For example, the processing element 800 may be a central processing unit, microprocessor, processor, or microcontroller. Additionally, it should be noted that some components of the agricultural system may be controlled by a first processing element 800 and other components may be controlled by a second processing element 800, where the first and second processing elements may or may not be in communication with each other.

The I/O interface 802 allows a user to enter data into an agricultural system, as well as provides an input/output for the agricultural system to communicate with other devices or services. The I/O interface 802 can include one or more input buttons, touch pads, touch screens, and so on.

The external device 810 are one or more devices that can be used to provide various inputs to the agricultural system, e.g., mouse, microphone, keyboard, trackpad, sensing element (e.g., a thermistor, humidity sensor, light detector, etc. The external devices 810 may be local or remote and may vary as desired. In some examples, the external devices 810 may also include one or more additional sensors.

The memory components 806 are used by the agricultural system to store instructions for the processing element 800 such as an application and/or user interface, as well as store data, such as light source 106 and/or air mover 108 settings, environmental characteristics, user preferences, alerts, etc. The memory components 806 may be, for example, magneto-optical storage, read-only memory, random access memory, erasable programmable memory, flash memory, or a combination of one or more types of memory components.

The network interface 808 provides communication to and from the agricultural system to other devices. The network interface 808 includes one or more communication protocols, such as, but not limited to Wi-Fi, Ethernet, Bluetooth, etc. The network interface 808 may also include one or more hardwired components, such as a Universal Serial Bus (USB) cable, or the like. The configuration of the network interface 808 depends on the types of communication desired and may be modified to communicate via Wi-Fi, Bluetooth, etc.

The display 804 provides a visual output for the agricultural system and may be varied as needed based on the device. The display 804 may be configured to provide visual feedback to a user and may include a liquid crystal display screen, light emitting diode screen, plasma screen, or the like. In some examples, the display 804 may be configured to act as an input element for the user through touch feedback or the like.

The power supply 812 may be any suitable device that can proved electrical power to the agricultural systems disclosed, for example to power the light source 106 and/or the air mover 108. In various embodiments, the power supply 812 may be an AC/DC power supply that converts alternating current (AC) to direct current (DC); an AC/AC power supply that converts AC power from a wall outlet to a different voltage or frequency of AC power, a wall plug such as a compact AC/DC power supply that plugs into a wall outlet and provides DC power to a device through a connector such as a USB port or a barrel plug, a battery, such as a primary battery that is non-rechargeable and are used once and then discarded, a secondary battery such as a rechargeable battery that can be recharged and used multiple times, or combinations of these.

Any description of a particular component being part of a particular embodiment, is meant as illustrative only and should not be interpreted as being required to be used with a particular embodiment or requiring other elements as shown in the depicted embodiment.

All relative and directional references (including top, bottom, side, front, rear, and so forth) are given by way of example to aid the reader's understanding of the examples described herein. They should not be read to be requirements or limitations, particularly as to the position, orientation, or use unless specifically set forth in the claims. Connection references (e.g., attached, coupled, connected, joined, and the like) are to be construed broadly and may include intermediate members between a connection of elements and relative movement between elements. As such, connection references do not necessarily infer that two elements are directly connected and in fixed relation to each other, unless specifically set forth in the claims.

The present disclosure teaches by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. An agricultural system comprising:
a core assembly including a housing forming main aperture;
a light source arranged circumferentially around the main aperture; and
one or more air movers directed toward the main aperture, wherein the main aperture defines an inlet and an outlet fluidically coupled by a flow passage formed by the housing.

2. The agricultural system of claim 1, further comprising an input configured to control an intensity of light emitted by the light source.

3. The agricultural system of claim 1, further comprising an input configured to control an intensity of airflow generated by the one or more air movers.

4. The agricultural system of claim 1, further comprising an input configured to control an operation time of the agricultural system.

5. The agricultural system of claim 1, wherein the housing is formed from a circumferential rim comprising a bottom portion, a mid portion, and a top portion.

6. The agricultural system of claim 1, wherein the core assembly is configured to provide light and air in a substantially same direction.

7. The agricultural system of claim 1, further comprising a light modifier arranged about the main aperture and adapted to modify light provided by the light source.

8. The agricultural system of claim 7, wherein the modification comprises at least one of collimating the light or diffusing the light.

9. The agricultural system of claim 7, wherein the light modifier comprises a lens or a diffuser.

10. The agricultural system of claim 7, wherein the light modifier comprises at least one of a Fresnel lens or a convex lens.

11. The agricultural system of claim 1, wherein the light source comprises a plurality of tunable LED emitters.

12. The agricultural system of claim 11, wherein the tunable LED emitters are adapted to change a light spectrum based on at least one of a plant species or growth stage.

13. The agricultural system of claim 11, wherein the air mover comprises a fan driven by a pulse-width-modulation signal, a DC signal, or an AC signal and configured to provide adjustable airflow based on at least one of a plant species or growth stage.

14. The agricultural system of claim 11, further comprising:
a base adapted to stably support the agricultural system on a support surface; and
a support coupled to the housing and the base.

15. The agricultural system of claim 14, wherein the support comprises at least one of an elongated rod or a cord.

16. The agricultural system of claim 14, wherein the support is adjustable in length.

17. The agricultural system of claim 1, further comprising at least one nacelle adapted to house at least one respective air mover of the one or more air movers.

18. The agricultural system of claim 17, wherein the at least one nacelle is pivotable about at least one axis.

19. The agricultural system of claim 17, wherein the at least one nacelle is pivotable about at least two axes.

20. The agricultural system of claim 19, wherein the at least two axes are disposed at an angle with respect to one another.

21. The agricultural system of claim 20, wherein the angle is 90° or less.
